(19) United States
(12) Patent Application Publication
(10) Pub. No.: US 2025/0372297 A1
(43) Pub. Date: Dec. 4, 2025

(54) MAGNETIC COMPONENT AND CIRCUIT BOARD ASSEMBLY USING THE SAME

(71) Applicant: LITE-ON TECHNOLOGY CORPORATION, Taipei (TW)

(72) Inventors: Chen CHEN, Taipei (TW); Cheng-Wei Tseng, Taipei (TW); Kai-De Chen, Taipei (TW); Yong-Long Syu, Taipei (TW)

(21) Appl. No.: 18/983,423

(22) Filed: Dec. 17, 2024

Related U.S. Application Data
(60) Provisional application No. 63/655,657, filed on Jun. 4, 2024.

(30) Foreign Application Priority Data
Oct. 24, 2024 (CN) 202411492822.6

(51) Int. Cl. H01F 27/30; H01F 27/06

(52) U.S. Cl. CPC H01F 27/306; H01F 27/06; H01F 2027/065

(57) ABSTRACT

A magnetic component includes a bottom plate, a cover plate, a first winding post, a second winding post, a primary winding and a secondary winding. The cover plate and the bottom plate are disposed oppositely. The first winding post is disposed between the bottom plate and the cover plate. The second winding post is disposed between the bottom plate and the cover plate. The primary winding is wound on the first winding post. The secondary winding is wound on the second winding post.

This application claims the benefit of US provisional application Serial No. 63/655,657, filed June 4, 2024, the subject matter of which is incorporated herein by reference, and claims the benefit of People’s Republic of China application Serial No. 202411492822.6, filed on October 24, 2024, the subject matter of which is incorporated herein by reference.

### TECHNICAL FIELD

The disclosure relates in general to a magnetic component and a circuit board assembly using the same.

### BACKGROUND

Most isolated type DC-DC converters used in products, such as charger, server power supply, vehicle power supply and charging pile, adopt LLC series resonant converter. In comparison to other isolated type DC-DC converters, the LLC series resonant converter has the property of flexible switching in a full load range, and therefore can effectively reduce the switching loss under high-frequency switching.

A typical LLC series resonant converter includes a magnetic device with primary side coils and secondary side coils wound thereon. The magnetic device occupies major space of the LLC series resonant converter. Therefore, it has become a prominent task for the industries to provide a magnetic device having a reduced size and excellent energy conversion efficiency, and an LLC series resonant converter having the same.

### SUMMARY

The present disclosure provides a magnetic component and A circuit board assembly using the same capable of resolving the conventional problem.

According to an embodiment, a magnetic component is provided. The magnetic component includes a bottom plate, a cover plate, a first winding post, a second winding post, a third winding post, a primary winding, a first secondary winding and a second secondary winding. The cover plate is disposed opposite to the bottom plate. The first winding post is disposed between the bottom plate and the cover plate. The second winding post is disposed between the bottom plate and the cover plate. The third winding post is disposed between the bottom plate and the cover plate. The primary winding is wound around the first winding post. The first secondary winding is wound around the second winding post. The second secondary winding is wound on the third winding post. The first winding post extends along a first direction and has a first length, the second winding post and the third winding post are disposed along the first direction, there is a first interval between the second winding post and the third winding post, and the first length is greater than the first interval.

According to another embodiment, a circuit board assembly is provided. The circuit board assembly includes a circuit board, a magnetic component, a first switch group and a second switch group. The magnetic component is disposed on the circuit board and includes a bottom plate, a cover plate, a first winding post, a second winding post, a third winding post, a primary winding, a first secondary winding and a second secondary winding, wherein the cover plate and the bottom plate are disposed oppositely, the first winding post, the second winding post and the third winding post are disposed between the bottom plate and the cover plate, the primary winding is wound around the first winding post, the first secondary winding is wound around the second winding post, the second secondary winding is wound around the third winding post, the first winding post extends along a first direction and has a first length, the second winding post and the third winding post are disposed along the first direction, there is a first interval between the second winding post and the third winding post, and the first length is greater than the first interval. The first switch group is disposed on the circuit board and coupled to the primary winding. The second switch group is disposed on the circuit board and coupled to the first secondary winding and the second secondary winding.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 illustrates an equivalent circuit diagram of a circuit board assembly according to an embodiment of the present invention;

FIG. 2A illustrates a schematic diagram of the structure of the magnetic component in FIG. 1;

FIG. 2B illustrates that a primary winding in FIG. 1 disposed on a first winding post in FIG. 2A, and a first secondary winding and a second secondary winding respectively disposed on a second winding post and a third winding post in FIG. 2A;

FIG. 2C illustrates a schematic diagram of a top view of the magnetic component in FIG. 2B (the cover plate is omitted);

FIG. 3 illustrates a schematic diagram of a leakage magnetic flux of the magnetic component in FIG. 2B;

FIG. 4 illustrates a schematic diagram of the circuit board assembly 10 according to an embodiment of the present invention;

FIG. 5 illustrates a schematic diagram of a circuit board assembly according to another embodiment of the present invention;

FIG. 6 illustrates a schematic diagram of a circuit board assembly according to another embodiment of the present invention;

FIG. 7 illustrates a schematic diagram of a magnetic component according to another embodiment of the present invention; and

FIG. 8 illustrates an equivalent circuit diagram of the circuit board assembly according to another embodiment of the present invention.

### DETAILED DESCRIPTION

The embodiment illustrated below provides a magnetic component and a circuit board assembly using the same, which may reduce the size, volume and weight of the magnetic component and the circuit board assembly using the same without affecting the overall performance, and may reduce the production cost of the circuit board assembly. The claimed invention will be described in more detail below with reference to specific embodiments with reference to the structures and arrangements described in the specification.

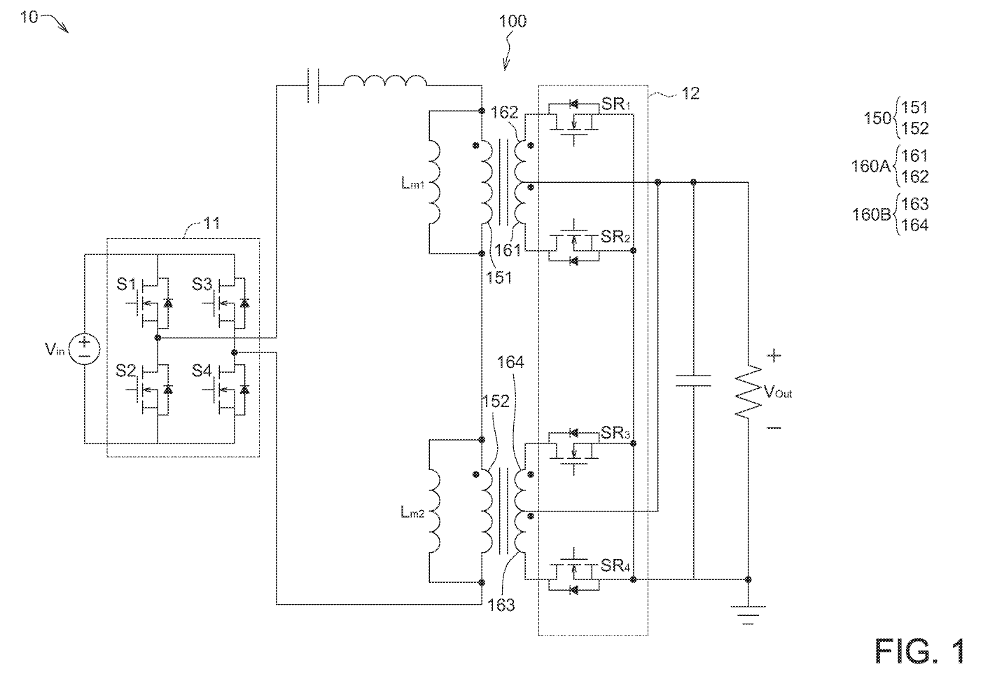

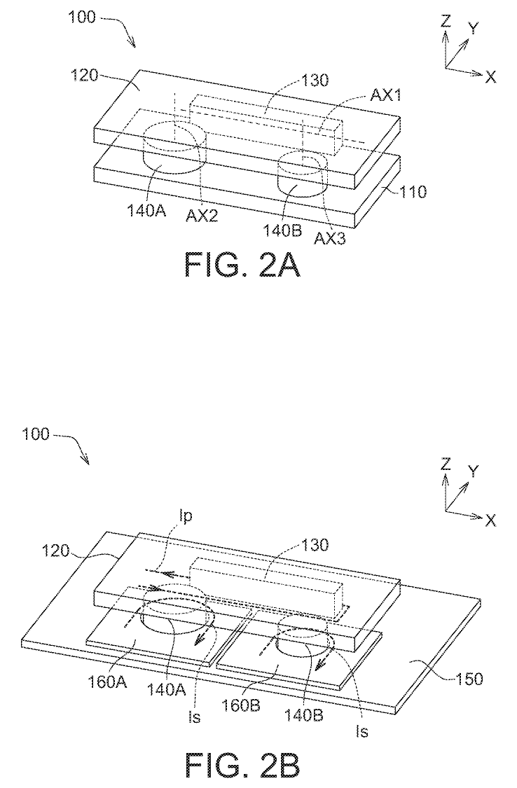

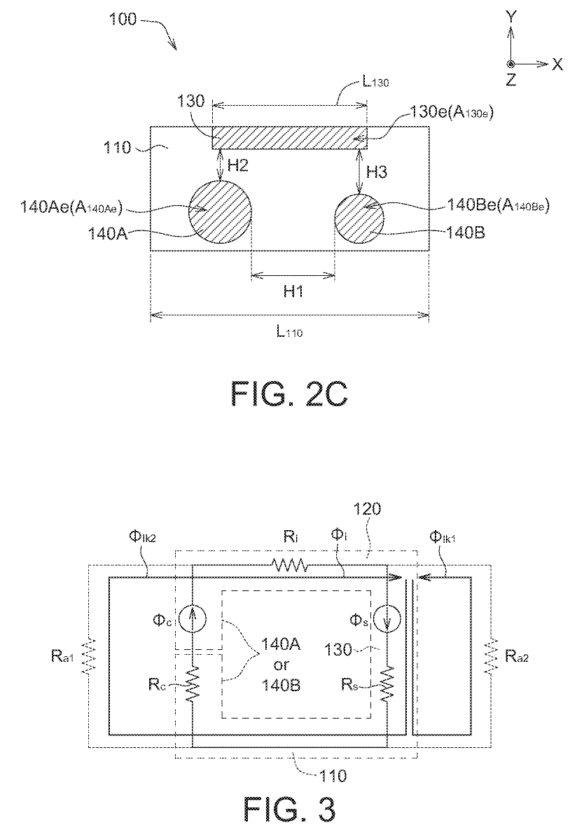

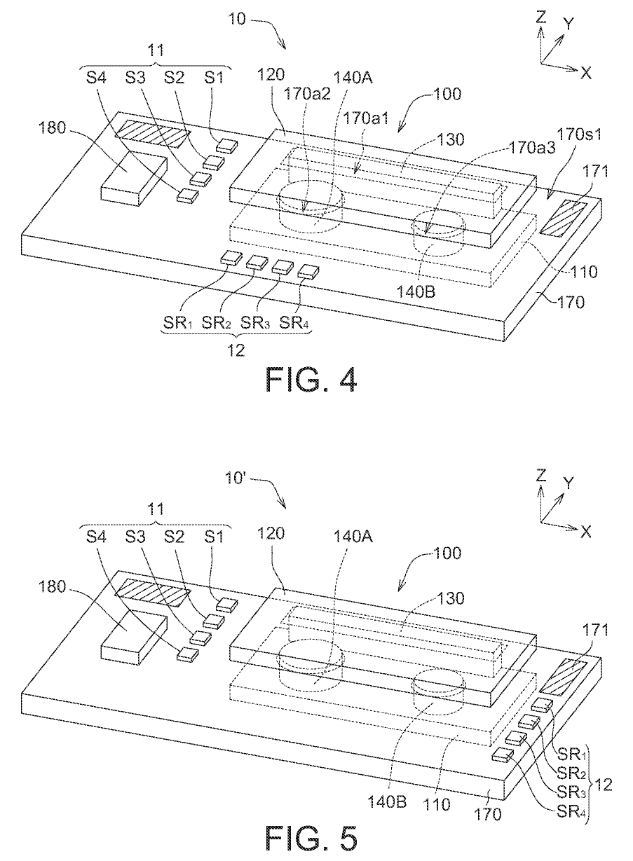

Referring to FIGS. 1, 2A to 2C, 3 and 4, FIG. 1 illustrates an equivalent circuit diagram of a circuit board assembly 10 according to an embodiment of the present invention, FIG. 2A illustrates a schematic diagram of the structure of the magnetic component 100 in FIG. 1, FIG. 2B illustrates that a primary winding 150 in FIG. 1 disposed on a first winding post 130 in FIG. 2A, and a first secondary winding 160A and a second secondary winding 160B respectively disposed on a second winding post 140A and a third winding post 140B in FIG. 2A, FIG. 2C illustrates a schematic diagram of a top view of the magnetic component 100 in FIG. 2B (the cover plate 120 is omitted), FIG. 3 illustrates a schematic diagram of a leakage magnetic flux of the magnetic component 100 in FIG. 2B, and FIG. 4 illustrates a schematic diagram of the circuit board assembly 10 according to an embodiment of the present invention.

As illustrated in FIGS. 1 and 4, in the present embodiment, the circuit board assembly 10 includes, for example, an LLC series resonant converter, but the embodiment of the present invention is not limited to this. The circuit board assembly 10 at least includes a circuit board 170 (illustrated in FIG. 4), at least one magnetic component 100, a first switch group 11 and a second switch group 12.

As illustrated in FIGS. 2A, 2B and 4, the magnetic component 100 at least includes a bottom plate 110, a cover plate 120, the first winding post 130, the second winding post 140A, the third winding post 140B, the primary winding 150, the first secondary winding 160A, the second secondary winding 160B, the circuit board 170 (the circuit board 170 is illustrated in FIG. 4) and a semiconductor chip 180 (the semiconductor chip 180 is illustrated in FIG. 4). The cover plate 120 and the bottom plate 110 are disposed opposite to each other. The first winding post 130, the second winding post 140A and the third winding post 140B may be disposed between the bottom plate 110 and the cover plate 120. The primary winding 150 is wound around the first winding post 130. The first secondary winding 160A and the second secondary winding 160B are respectively wound around the second winding post 140A and the third winding post 140B. Since the primary winding 150 is wound around the first winding post 130, the leakage inductance may be increased, so there is no need to dispose an additional inductor (this additional inductance leads to an increase in floor space and copper loss), and accordingly it may increase space utilization and reduce overall energy loss (for example, the sum of copper loss and iron loss/core loss). The units of "copper loss" and "iron loss" in this article are, for example, Watt (W).

As illustrated in FIG. 2C, in an embodiment, the first winding post 130 extends along a first direction X and has a first length L₁₃₀, and the second winding post 140A and the third winding post 140B are disposed along the first direction X, and has a first interval H1 (for example, the shortest interval) therebetween, wherein the first length L₁₃₀ is greater than the first interval H1.

As illustrated in FIGS. 1 and 4, the first switch group 11 is disposed on the circuit board 170 and coupled to the primary winding 150. The first switch group 11 includes a plurality of switches, for example, a first switch S1, a second switch S2, a third switch S3 and a fourth switch S4. The first switch S1, the second switch S2, the third switch S3 and the fourth switch S4 are electrically connected to an input terminal Vᵢₙ and the primary winding 150 of the magnetic component 100. The second switch group 12 is disposed on the circuit board 170 and coupled to the first secondary winding 160A and the second secondary winding 160B, and at least includes a plurality of rectifier switches SR₁, SR₂, SR₃ and SR₄. The rectifier switches SR₁, SR₂, SR₃ and SR₄ connect the secondary windings (160A and 160B) of the magnetic component 100 and the output terminal Vₒᵤₜ. In addition, the first switch group 11 is disposed on a first side of the magnetic component 100, and the second switch group 12 is disposed on a second side of the magnetic component 100, wherein the first side and the second side are two adjacent sides of the magnetic component 100.

In the present embodiment, the bottom plate 110, the cover plate 120, the first winding post 130, the second winding post 140A and the third winding post 140B are, for example, iron cores.

In a comparative example, compared to a magnetic component with an additional inductor, the magnetic component (without an additional inductor) according to the embodiment of the present invention may occupy an area (in terms of iron core) which is reduced by, for example, about 30%, and the copper loss may be reduced by, for example, about 16.3% (because no additional inductor is needed), while the iron loss may be increased by, for example, about 5.6%. It is worth noting that the total loss is still decreased by 9.1% although the iron loss is increased.

As illustrated in FIG. 3, the magnetic resistance Rᵢ represents the magnetic resistance of the cover plate 120, and the magnetic flux Φᵢ represents the magnetic flux passing through the cross section of the cover plate 120. The magnetic resistance R_{C} represents the magnetic resistance of the second winding post 140A or the third winding post 140B. The magnetic flux Φ_{C} represents the magnetic flux passing through the cross section of the second winding post 140A or the third winding post 140B. The magnetic resistance R_{S} represents the magnetic resistance of the first winding post 130, and the magnetic flux Φ_{S} represents the magnetic flux passing through the cross section of the first winding post 130. The magnetic resistance Rₐ₁ is the air reluctance on the side of the secondary winding, and the magnetic resistance Rₐ₂ is the air magnetic resistance on the side of the primary winding. The first leakage magnetic flux Φ_{IK1} is not coupled with the secondary windings 160A and 160B (not illustrated in FIG. 3) but its magnetic flux path passes through the first winding post 130, which causes additional iron loss. A static current of the magnetic flux path of the second leakage magnetic flux Φ_{IK2} around the first secondary winding 160A or the second secondary winding 160B (not illustrated in FIG. 3) is 0 amperes, which is not coupled with the secondary winding (160A or 160B) but flows through the first winding post 130, the bottom plate 110 and the cover plate 120, and thus it cause additional iron loss. In addition, through magnetoresistance analysis, the first leakage magnetic flux Φ_{IK1} and the second leakage magnetic flux Φ_{IK2} increase significantly, and it significantly increase the leakage inductance.

In a comparative example, the primary winding 150 is wound around the second winding post 140A and the third winding post 140B (that is, not around the first winding post 130), which generates approximately the leakage inductance of 8.79 nH. Compared with this comparative example, the primary winding 150 of the embodiment of the present invention is wound on the first winding post 130, which generates the leakage inductance of approximately 454 nH. Compared with the comparative example, the leakage inductance of the magnetic component 100 of the embodiment of the present invention is increased by at least 51 times. In addition, in the comparative example, the primary winding 150 is wound around the second winding post (not around the first winding post 130), which generates a copper loss of approximately 15.16 W and an iron loss of 8.21 W. Compared with this comparative example, the primary winding 150 of the embodiment of the present invention is wound on the first winding post 130, which generates the copper loss of approximately 17.23 W and the an iron loss of 10.75 W.

As illustrated in FIG. 2A, the projection of the first winding post 130 along a second direction Y at least partially overlaps with the second winding post 140A and the third winding post 140B. Furthermore, a projection area where the second winding post 140A and/or the third winding post 140B is projected to the first winding post 130 along the second direction Y at least partially overlaps the first winding post 130. The aforementioned second direction Y is different from the first direction X. For example, the second direction Y and the first direction X are substantially perpendicular.

As illustrated in FIG. 2A, an extension direction of the first winding post 130 is different from an extension direction of the second winding post 140A and/or the third winding post 140B. For example, an extension axis (or long axis) AX1 of the first winding post 130 extends along the first direction X, and an extension axis (or central axis) AX2 of the second winding post 140A and/or an extension axis (or central axis) AX3 of the third winding post 140B extends along a third direction Z, wherein the third direction Z is different from the first direction X. For example, the first direction X and the third direction Z are perpendicular to each other. Furthermore, the first winding post 130 is, for example, a polyhedral post (for example, a triangular post, a quadrangular post, etc.), and the second winding post 140A and/or the third winding post 140B is, for example, a cylinder or an elliptical post. However, the embodiment of the present invention does not limit the cross-sectional shape of the winding post.

As illustrated in FIG. 2B, in the present embodiment, the second winding post 140A and the third winding post 140B may be separately disposed along the first direction X. The first secondary winding 160A and the second secondary winding 160B are wound around the second winding post 140A and the third winding post 140B respectively. In another embodiment, the magnetic component 100 may omit the third winding post 140B.

The primary winding 150 and the secondary windings (160A and 160B) illustrated in FIG. 2B are for illustration only. I_{P} in FIG. 2B represents a current direction of the primary winding 150, and I_{S} represents a current direction of the secondary winding 160. In the figure, the current direction I_{P} represents a winding direction or pattern of the primary winding 150, while the current direction I_{S} represents a winding direction or pattern of the secondary winding. The embodiment of the present invention does not limit the specific winding method of the primary winding 150 and the secondary winding (160A and 160B).

As illustrated in FIGS. 2A and 2C, a connection surface (for example, contact surface) between the first winding post 130 and the cover plate 120 has a first area, a connection surface (for example, contact surface) between the second winding post 140A and the cover plate 120 has a second area, and a connection surface (for example, contact surface) of the third winding post 140A and the cover plate 120 has a third area, wherein a ratio of the first area to the sum of the second area and the third area may be approximately between 80% and 150%. For example, a connection surface 130e of the first winding post 130 and the cover plate 120 has a first area A₁₃₀ₑ, a connection surface 140Ae of the second winding post 140A and the cover plate 120 has a second area A_{140Ae}, and a connection surface 140Be of the third winding post 140B and the cover plate 120 has a third area A_{140Be}. The sum of the second area A_{140Ae} and the third area A_{140Be} is an area sum A'₁₄₀ₑ, wherein the ratio of the first area A₁₃₀ₑ to the area sum A'₁₄₀ₑ (that is, A₁₃₀ₑ/A'₁₄₀ₑ) ranges, for example, between 80% and 150%, for example, 80%, 90%, 100%, 110%, 120%, 130%, 140% or 150%, etc., but it may also be higher or lower.

As illustrated in FIG. 2C, a ratio of the second area to the third area may range between 80% and 120%. For example, the second area A_{140Ae} of the connection surface 140Ae and the third area A_{140Be} of the connection surface 140Be may be the same or different. In an embodiment, a ratio of one of the second area A_{140Ae} and the third area A_{140Be} to the other of the second area A_{140Ae} and the third area A_{140Be} may range between 80% and 120%, for example, 80%, 90%, 100%, 110% or 120%, etc., but it may also be higher or lower.

As illustrated in FIG. 2C, in an embodiment, the bottom plate 110 has a bottom plate length L₁₁₀ along the first direction X, a ratio of the first length L₁₃₀ to the bottom plate length L₁₁₀ may range between, for example, 50% and 100%, for example, 50%, 60%, 70%, 80%, 90% or 100%, etc., but it may also be higher or lower. In other embodiment, there is a second interval H2 (for example, the shortest interval) between the first winding post 130 and the second winding post 140A along the second direction Y. There is a third interval H3 (for example, the shortest interval) between the first winding post 130 and the third winding post 140B along the second direction Y, and a ratio of the sum of the second interval H2 and the third interval H3 to the first interval H1 ranges between, for example, 80 % and 120%, for example, 80%, 90%, 100%, 110% or 120%, etc., but it may also be higher or lower.

As illustrated in FIG. 4, the circuit board 170 has at least one heat dissipation region 171, and the heat dissipation region 171 is formed of metal material, such as a metal pad. The area of the heat dissipation region 171 may be less than the area of the cover plate 120. For example, the heat dissipation region 171 is exposed from a first surface 170s1 of the circuit board 170, and the area of the heat dissipation region 171 may be less than a projected area of the cover plate 120 projected onto the first surface 170s1. In an embodiment, the area of each heat dissipation region 171 is less than the area of the cover plate 120. In another embodiment, a total area of the plurality of the heat dissipation regions 171 may be less than or greater than the area of the cover plate 120. The arrangement position, the number and/or the area of the heat dissipation regions 171 may depend on the configuration of the electronic components (for example, the magnetic components 100, the switch groups, chips, resistors, etc.) and the required heat dissipation efficiency, and it is not limited by the embodiment of the present invention.

The following introduces the relationship between the winding design in FIG. 2B and the circuit design in FIG. 1.

As illustrated in FIGS. 2B and 1, the primary winding 150 includes at least one primary sub-winding, for example, a first primary sub-winding 151 and a second primary sub-winding 152. The secondary winding includes at least one primary sub-winding. For example, the first secondary winding 160A includes a first secondary sub-winding 161 and a second secondary sub-winding 162, and the second secondary winding 160B includes a third secondary sub-winding 163 and a fourth secondary sub-winding 164. In the embodiment, the first secondary sub-winding 161 is, for example, a first secondary-side positive half-cycle sub-winding, the second secondary sub-winding 162 is, for example, a first secondary-side negative half-cycle sub-winding, the third secondary sub-winding 163 is, for example, a second secondary-side positive half-cycle sub-winding, and the fourth secondary sub-winding 164 is, for example, a second secondary-side negative half-cycle sub-winding. The first primary sub-winding 151 and the second primary sub-winding 152 are connected in series and are electrically connected to the first switch group 11. The first secondary sub-winding 161 and the third secondary sub-winding 163 are connected in parallel with each other and are electrically connected to the second switch group 12. The first secondary sub-winding 161 and the second secondary sub-winding 162 are electrically connected and form a first center-tap structure. The third secondary sub-winding 163 and the fourth secondary sub-winding 164 are electrically connected and form a second center-tap structure.

As illustrated in FIGS. 2B and 1, the rectifier switch SR₂ connects the first secondary sub-winding 161 with the output terminal Vₒᵤₜ. The rectifier switch SR₁ connects the second secondary sub-winding 162 with the output terminal Vₒᵤₜ and is connected with the rectifier switch SR₂ in parallel in opposite directions. The rectifier switch SR₄ connects the third secondary sub-winding 163 with the output terminal Vₒᵤₜ. The rectifier switch SR₃ connects the fourth secondary sub-winding 164 with the output terminal Vₒᵤₜ and is connected with the rectifier switch SR₄ in parallel in opposite directions. As a result, the magnetic component 100 forms two center-tap rectifier circuits.

As illustrated in FIG. 1, when the first switch S1 and the fourth switch S4 are turned on, the second switch S2 and the third switch S3 are turned off, so that the input current flows through the first primary sub-winding 151 and the second primary sub-winding 152. The rectifier switch SR₂ and the rectifier switch SR₄ are turned on at the same time, and it causes the induced current flows through the first secondary sub-winding 161 and the third secondary sub-winding 163 at the same time. At this time, the induced current flowing through the first secondary sub-winding 161 and the third secondary sub-winding 163 has a current conduction direction opposite to the input current flowing through the first primary sub-winding 151 and the second primary sub-winding 152.

When the second switch S2 and the third switch S3 are turned on, the first switch S1 and the fourth switch S4 are turned off, so that the input current flows through the first primary sub-winding 151 and the second primary sub-winding 152. The rectifier switch SR₁ and the rectifier switch SR₃ are turned on at the same time, and it caused the induced current to flow through the second secondary sub-winding 162 and the fourth secondary sub-winding 164 at the same time. At this time, the induced current flowing through the second secondary sub-winding 162 and the fourth secondary sub-winding 164 has a current conduction direction opposite to the input current flowing through the first primary sub-winding 151 and the second primary sub-winding 152.

As illustrated in FIG. 4, the magnetic component 100 including the circuit board 170 may also be called a flat-type magnetic component. In another embodiment, the circuit board 170 and the magnetic component 100 may be subcomponents of the circuit board assembly 10 in the same level. The circuit board 170 may be disposed between the cover plate 120 and the bottom plate 110. Although not illustrated, the circuit board 170 may have a first through hole 170a1, a second through hole 170a2 and a third through hole 170a3, wherein the first through hole 170a1 allows the primary winding 150 to pass through, the second through hole 170a2 allows the first through hole 170a2 to pass through, and the secondary winding 160A passes through, and the third through hole 170a3 allows the second secondary winding 160B to pass through. The circuit board 170 is, for example, a printed circuit board (PCB).

Although not illustrated, the primary winding 150 and the secondary windings (160A and 160B) of FIG. 2B may be disposed in the circuit board 170. For example, the circuit board 170 may be a multi-layer circuit board, which may include multiple-layered trace along a thickness direction, and the adjacent two trace layers in adjacent two levels may be electrically connected through conductive holes (not illustrated), wherein the primary winding 150 may be located at least one layer of the circuit board 170, the secondary windings (160A and 160B) may be located on at least one layer of the circuit board 170, and the primary winding 150 and the secondary windings (160A and 160B) may be located on two different two trace layers of the circuit board 170.

Although not illustrated, the primary winding 150 and/or the secondary winding 160 located in the circuit board 170 may be electrically connected to the rectifier switches SR₁, SR₂, SR₃ and SR₄ and the first switch S1, the second switch S2, the third switch S3 and the fourth switch S4 through at least one conductive hole and/or at least one routing (for example, the trace layer disposed on the circuit board 170).

Referring to FIG. 5, FIG. 5 illustrates a schematic diagram of a circuit board assembly 10' according to another embodiment of the present invention. The circuit board assembly 10' at least includes the circuit board 170, at least one magnetic component 100, the first switch group 11 and the second switch group 12. The circuit board assembly 10' includes the technical features the same as or similar to that of the aforementioned circuit board assembly 10, and at least one difference is that the first switch group 11 and the second switch group 12 are respectively disposed on two opposite sides of the magnetic component 100.

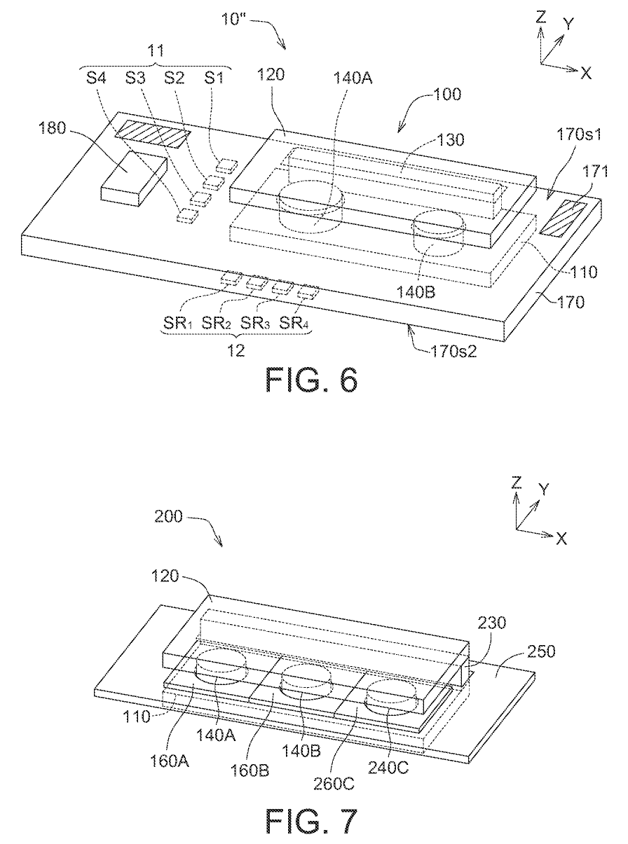

Referring to FIG. 6, FIG. 6 illustrates a schematic diagram of a circuit board assembly 10'' according to another embodiment of the present invention. The circuit board assembly 10'' at least includes the circuit board 170, at least one magnetic component 100, the first switch group 11 and the second switch group 12. The circuit board assembly 10'' includes the technical features the same as or similar to that of the aforementioned circuit board assembly 10. At least one difference is that the first switch group 11 is disposed on the first surface 170s1 of the circuit board 170, and the second switch group 12 is disposed on a second surface 170s2 of the circuit board 170, wherein the first surface 170s1 and the second surface 170s2 are two opposite sides of the circuit board 170. In an embodiment, an area of the first switch group 11 projected onto the second surface 170s2 in a direction perpendicular to the second surface 170s2 may not overlap at all with the second switch group 12, but it may also at least partially overlap.

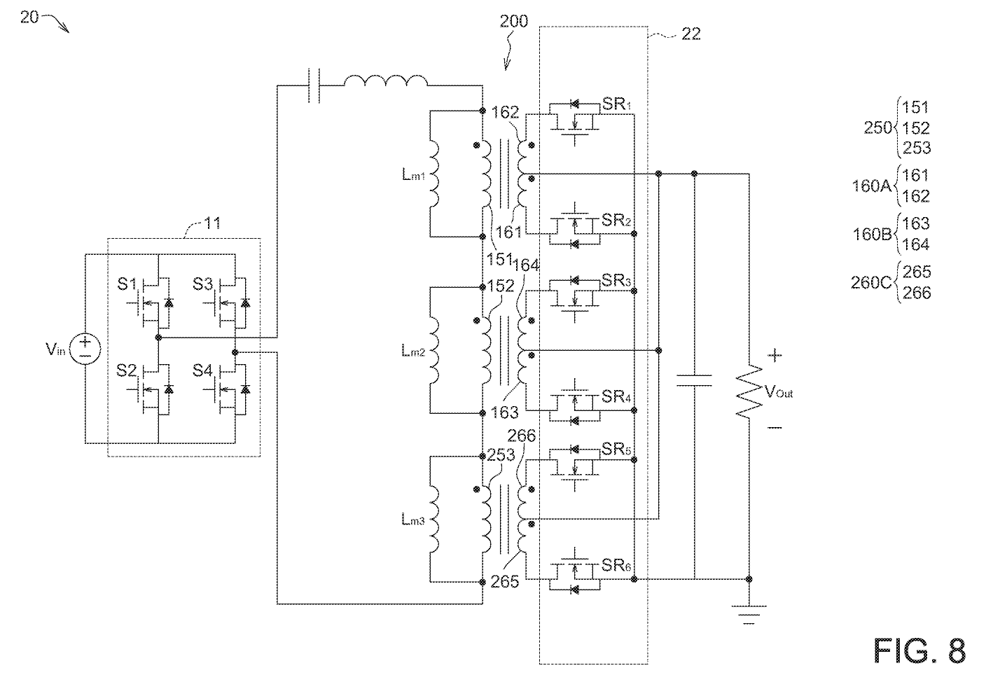

Referring to FIGS. 7 and 8, FIG. 7 illustrates a schematic diagram of a magnetic component 200 according to another embodiment of the present invention, and FIG. 8 illustrates an equivalent circuit diagram of the circuit board assembly 20 according to another embodiment of the present invention.

As illustrated in FIG. 7, the magnetic component 200 at least includes the bottom plate 110, the cover plate 120, a first winding post 230, the second winding post 140A, the third winding post 140B, a fourth winding post 240C, a primary winding 250 (not illustrated), at least one secondary winding (for example, the first secondary winding 160A, the second secondary winding 160B and a third secondary winding 260C), a circuit board (not illustrated) and a semiconductor chip (not illustrated). The cover plate 120 and the bottom plate 110 are disposed opposite to each other. The first winding post 230 is disposed between the bottom plate 110 and the cover plate 120. The second winding post 140A, the third winding post 140B and the fourth winding post 240C may be disposed between the bottom plate 110 and the cover plate 120. The primary winding 250 is wound around the first winding post 230. The first secondary winding 160A, the second secondary winding 160B and the third secondary winding 260C are respectively wound around the second winding post 140A, the third winding post 140B and the fourth winding post 240C. Due to the primary winding 250 being wound around the first winding post 230, the leakage inductance may be increased, so there is no need to dispose an additional inductor (such additional inductor leads to an increase in floor space and copper loss), and accordingly it may increase the space utilization, reduce overall energy loss (for example, the sum of copper loss and iron loss).

As illustrated in FIG. 8, the circuit board assembly 20 includes, for example, an LLC series circuit board, but the embodiment of the present invention is not limited to this. The circuit board assembly 20 at least includes the circuit board 170 (illustrated in FIG. 4), at least one magnetic component 200, the first switch group 11 and a second switch group 22.

As illustrated in FIG. 8, the first switch group 11 is disposed on the circuit board 170 (the circuit board 170 is illustrated in FIG. 4) and coupled with the primary winding 150. The first switch group 11 includes a plurality of the switches, for example, the first switch S1, the second switch S2, the third switch S3 and the fourth switch S4. The first switch S1, the second switch S2, the third switch S3 and the fourth switch S4 are electrically connected to the input terminal Vᵢₙ with the primary winding 250 of the magnetic component 200. The second switch group 22 is disposed on the circuit board 170 (the circuit board 170 is illustrated in FIG. 4 ) and is coupled to the first secondary winding 160A, the second secondary winding 160B and the third secondary winding 260C and at least includes the rectifier switches SR₁, SR₂, SR₃, SR₄, SR₅ and SR₆. The rectifier switches SR₁, SR₂, SR₃, SR₄, SR₅ and SR₆ connect the secondary windings (160A, 160B and 260C) of the magnetic component 200 with the output terminal Vₒᵤₜ. In addition, the first switch group 11 is disposed on a first side of the magnetic component 200, and the second switch group 22 is disposed on a second side of the magnetic component 200, wherein the first side and the second side are two adjacent sides of the magnetic component 200 or two opposite sides of the magnetic component 200.

As illustrated in FIG. 8, the primary winding 250 includes the first primary sub-winding 151, the second primary sub-winding 152 and a third primary sub-winding 253. The secondary winding includes at least one primary sub-winding. For example, the first secondary winding 160A includes the first secondary sub-winding 161 and the second secondary sub-winding 162, the second secondary winding 160B includes the third secondary sub-winding 163 and the fourth secondary sub-winding 164, and the third secondary winding 260C includes a fifth secondary sub-winding 265 and a sixth secondary sub-winding 266. In the present embodiment, the first secondary sub-winding 161 is, for example, the first secondary-side positive half-cycle sub-winding, the second secondary sub-winding 162 is, for example, the first secondary-side negative half-cycle sub-winding, and the third secondary sub-winding 163 For example, it is the second secondary-side positive half-cycle sub-winding, the fourth secondary sub-winding 164 is, for example, the second secondary-side negative half-cycle sub-winding, the fifth secondary sub-winding 265 is, for example, a third first secondary-side positive half-cycle sub-winding, and the sixth secondary sub-winding 266 is, for example, a third secondary-side negative half-cycle sub-winding. The first primary sub-winding 151 , the second primary sub-winding 152 and the third primary sub-winding 253 are connected in series and are electrically connected to the switch circuit 11. The first secondary sub-winding 161 and the third secondary sub-winding 163 are connected in parallel with each other and are electrically connected to the second switch group 22. The third secondary sub-winding 163 and the fifth secondary sub-winding 265 are connected in parallel with each other and are electrically connected to the second switch group 22. The first secondary sub-winding 161 and the second secondary sub-winding 162 are electrically connected and form a first center-tap structure, and the third secondary sub-winding 163 and the fourth secondary sub-winding 164 are electrically connected and form a second center-tap structure, and the fifth secondary sub-winding 265 and the sixth secondary sub-winding 266 are electrically connected and form a third center-tap structure.

As illustrated in FIG. 8, the rectifier switch SR₂ connects the first secondary sub-winding 161 with the output terminal Vₒᵤₜ. The rectifier switch SR₁ connects the second secondary sub-winding 162 with the output terminal Vₒᵤₜ, and is connected with the rectifier switch SR₂ in parallel in opposite directions. The rectifier switch SR₄ connects the third secondary sub-winding 163 with the output terminal Vₒᵤₜ, and the rectifier switch SR₃ connects the fourth secondary sub-winding 164 with the output terminal Vₒᵤₜ, and is connected with the rectifier switch SR₄ in parallel in opposite directions. The rectifier switch SR₅ connects the sixth secondary sub-winding 266 and the output terminal Vₒᵤₜ, and is connected with the rectifier switch SR₆ in parallel in opposite directions.

In summary, embodiments of the present invention provide a magnetic component and a circuit board assembly using the same. The magnetic component is, for example, a transformer. The magnetic component may include a plurality of winding posts, a primary winding and a secondary winding. Since the primary winding and the secondary winding are respectively wound around multiple different winding posts, the leakage inductance may be increased, so there is no need to dispose an additional inductor, thereby increasing the space utilization and reducing overall energy loss. In an embodiment, the connection surface between the first winding post and the cover plate has a first area, the connection surface between the second winding post and the cover plate has a second area, and the connection surface between the third winding post and the cover plate has a three area, wherein a ratio of the first area to the sum of the second area and the third area may range between 80% and 150%, but it may also be higher or lower. In another embodiment, a ratio of the second area to the third area may range between 80% and 120%, but it may also be higher or lower. In another embodiment, the first winding post has a first length in a direction, and the bottom plate has a bottom plate length in such direction, wherein a ratio of the first length to the bottom plate length may range between 50% and 100%, but it may also be higher or lower. In another embodiment, there is a first interval between the second winding post and the third winding post, there is a second interval between the first winding post and the second winding post, and a third interval between the first winding post and the third winding post, wherein a ratio of the sum of the second interval and the third interval to the first interval may range between 80% and 120%.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A magnetic component, comprising :
a bottom plate;
a cover plate disposed opposite to the bottom plate;
a first winding post disposed between the bottom plate and the cover plate;
a second winding post disposed between the bottom plate and the cover plate;
a third winding post disposed between the bottom plate and the cover plate;
a primary winding wound around the first winding post;
a first secondary winding wound around the second winding post; and
a second secondary winding wound on the third winding post,
wherein the first winding post extends along a first direction and has a first length, the second winding post and the third winding post are disposed along the first direction, there is a first interval between the second winding post and the third winding post, and the first length is greater than the first interval.

2. The magnetic component according to claim 1, wherein a projection of the first winding post along a second direction at least partially overlaps the second winding post and the third winding post.

3. The magnetic component according to claim 1, wherein a connection surface between the first winding post and the cover plate has a first area, and a connection surface between the second winding post and the cover plate has a second area, a connecting surface of the third winding post and the cover plate has a third area, and a ratio of the first area to a sum of the second area and the third area ranges between 80% and 150%.

4. The magnetic component according to claim 1, wherein a connection surface between the second winding post and the cover plate has a second area, and a connection surface between the third winding post and the cover plate has a third area, and a ratio of the second area to the third area ranges between 80% and 120%.

5. The magnetic component according to claim 1, wherein the bottom plate has a bottom plate length along a first direction, and a ratio of the first length to the bottom plate length ranges between 50% and 100%.

6. The magnetic component according to claim 1, wherein there is a second interval between the first winding post and the second winding post along a second direction, there is a third interval between the first winding post and the third winding post along the second direction, and a ratio of a sum of the second interval and the third interval to the first interval ranges between 80% and 120%.

7. The magnetic component according to claim 1, further comprising:
a circuit board disposed between the cover plate and the bottom plate;
wherein the primary winding, the first secondary winding and the second secondary winding are disposed on the circuit board.

8. The magnetic component according to claim 1, further comprising:
a first leakage magnetic flux whose magnetic flux paths passes through the first winding post; and
a second leakage magnetic flux whose magnetic flux paths passes through the first winding post, the bottom plate and the cover plate;
wherein neither the first leakage magnetic flux nor the second leakage magnetic flux is not coupled with the first secondary winding and the second secondary winding.

9. The magnetic component according to claim 8, wherein a static current of the magnetic flux path of the second leakage flux surrounding the first secondary winding or the second secondary winding is 0 ampere.

10. A circuit board assembly, comprising:
a circuit board;
a magnetic component disposed on the circuit board and comprising a bottom plate, a cover plate, a first winding post, a second winding post, a third winding post, a primary winding, a first secondary winding and a second secondary winding, wherein the cover plate and the bottom plate are disposed oppositely, the first winding post, the second winding post and the third winding post are disposed between the bottom plate and the cover plate, the primary winding is wound around the first winding post, the first secondary winding is wound around the second winding post, the second secondary winding is wound around the third winding post, the first winding post extends along a first direction and has a first length, the second winding post and the third winding post are disposed along the first direction, there is a first interval between the second winding post and the third winding post along the first direction, and the first length is greater than the first interval;
a first switch group disposed on the circuit board and coupled to the primary winding; and
a second switch group disposed on the circuit board and coupled to the first secondary winding and the second secondary winding.

11. The circuit board assembly according to claim 10, wherein a projection of the first winding post along a second direction at least partially overlaps the second winding post and the third winding post, and the second direction is perpendicular to the first direction.

12. The circuit board assembly according to claim 10, wherein the first switch group and the second switch group are disposed on two adjacent sides of the magnetic component respectively.

13. The circuit board assembly according to claim 10, wherein the first switch group is disposed on a first surface of the circuit board, the second switch group is disposed on a second surface of the circuit board, and the first surface and the second surface are two opposite sides of the circuit board respectively.

14. The circuit board assembly according to claim 13, wherein a projection of the first switch group along a direction perpendicular to the second surface does not overlap with the second switch group.

15. The circuit board assembly according to claim 10, wherein the circuit board has a heat dissipation region, the heat dissipation region is formed of metal, and an area of the heat dissipation region is smaller than an area of the cover plate.

16. The circuit board assembly according to claim 10, wherein the circuit board has a plurality of heat dissipation regions, the heat dissipation regions are formed of metal, and a total area of the heat dissipation regions is greater than an area of the cover plate.

17. The circuit board assembly according to claim 10, wherein the first switch group and the second switch group are disposed on two opposite sides of the magnetic component respectively.
